(19) United States
(12) Patent Application Publication
(10) Pub. No.: US 2022/0046910 A1
(43) Pub. Date: Feb. 17, 2022

(54) METHOD AND APPARATUS FOR BIRD CONTROL USING LASER

(71) Applicant: Ecolab USA Inc., Saint Paul, MN (US)

(72) Inventors: Larry Arvid Lake, Saint Paul, MN (US); Stephen John Barcay, Burnsville, MN (US); Terry Leland Elichuk, Eden Prairie, MN (US)

(21) Appl. No.: 16/994,176

(22) Filed: Aug. 14, 2020

(51) Int. Cl. A01M 29/10; A01M 31/00

(52) U.S. Cl. CPC A01M 29/10; A01M 31/002

(57) ABSTRACT

An example of an apparatus for excluding birds from an enclosure may include a laser projector configured to project one or more laser beams and a controller configured to control an activation, a direction, and/or a pattern of the projection of the one or more laser beams. In various embodiment, the control may be configured to receive a switch signal indicating a state of an entrance of the enclosure and to control the projection of the one or more laser beams using the switch signal.

### TECHNICAL FIELD

The present disclosure relates to methods and apparatus for bird control in and around enclosed structures using laser technology.

### BACK GR.OUND

Birds can create serious problems for commercial and residential property inhabitants and owners. Uncontrolled, birds will roost or nest in or around man-made structures, such as in food retail and warehouse facilities. They can deface structures causing property and structural damage, create an unsanitary environment with droppings and nesting material, cause food contamination and loss of product, transmit diseases to humans and animals, carry ectoparasites which may bite humans and/or contaminate food, cause economic loss due to the need to clean up after them and to repair damage, and be a nuisance to employees and customers. Bird issues can result in damage to business reputation and loss of business when merchandise and food items become littered with nesting debris and bird droppings, and can cause operations to shut down for pest bird removal, negatively impacting sales. Birds may remain and reproduce in the facility indefinitely if not properly controlled.

Environmental concerns and local laws can sometimes require that birds be released unharmed, which is complicated by the fact that many times the birds must be captured at inconvenient or inaccessible locations to be removed. Thus, there is a need to exclude birds from man-made structures in a humane manner.

### SUMMARY

An example of an apparatus for excluding birds from an enclosure may include a laser projector configured to project one or more laser beams and a controller configured to control an activation, a direction, and/or a pattern of the projection of the one or more laser beams. In various embodiment, the control may be configured to receive a switch signal indicating a state of an entrance of the enclosure and to control the projection of the one or more laser beams using the switch signal.

In another example, a system for deterring birds in and around an enclosure may include multiple laser units. The laser units may each include a laser projector configured to project one or more laser beams and a controller configured to control an activation, a direction, and/or a pattern of the projection of the one or more laser beams. At least one of the multiple laser units is an entrance unit with its controller configured to receive a switch signal indicative of a state of at least one entrance of the enclosure and to control the projection of the one or more laser beams from its laser projector using the switch signal.

An example of a method for bird control for an enclosure is also provided. The method may include providing one or more laser units each configured to project one or more laser beams and controlling an activation, a direction, and/or a pattern of the projection of the one or more laser beams. In various embodiments, the method includes designating at least one of the one or more laser units to be an entrance unit for preventing birds from entering the enclosure through at least one entrance of the enclosure, receiving a switch signal indicative of a state of that entrance, and controlling the projection of the one or more laser beams from the entrance unit using the switch signal.

This summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIGS. 1A-D illustrate representations of examples of birds, with FIG. 1A illustrating a representation of a female house sparrow, FIG. 1B illustrating a representation a male house sparrow, FIG. 1C illustrating a representation a starling, and FIG. 1D illustrating a representation a pigeon.

FIGS. 2A-D illustrate a flushing technique using tools such as a chasing rod, a flashlight, and a laser pointer, in accordance with various embodiments of the present subject matter, with FIG. 2A illustrating a bird in an enclosure such as a warehouse, FIG. 2B illustrating an example of the chase rod, FIG. 2C illustrating an example of the flashlight, and FIG. 2D illustrating an example of the laser pointer.

FIG. 3 illustrates a mist net system, in accordance with various embodiments of the present subject matter.

FIGS. 4A-C illustrate laser systems used with a mist net, with FIG. 4A illustrating a vertical laser system pointing up towards rafters, FIG. 4B illustrating a laser system pointing at a side angle towards rafters, and FIG. 4C illustrating a laser system pointing in the direction of a ridge line of a building and towards rafters, in accordance with various embodiments of the present subject matter.

FIG. 5 illustrates a laser system for bird control in and around an enclosure, in accordance with various embodiments of the present subject matter.

FIG. 6 illustrates a laser unit for use in a laser system for bird control, such as the laser system of FIG. 5, in accordance with various embodiments of the present subject matter.

FIG. 7 illustrates another laser unit for use in a laser system for bird control, such as the laser system of FIG. 5, in accordance with various embodiments of the present subject matter.

FIG. 8 illustrates another laser unit for use in a laser system for bird control, such as the laser system of FIG. 5, in accordance with various embodiments of the present subject matter.

FIG. 9 illustrates a visual deterrent unit for use in a system for animal control, in accordance with various embodiments of the present subject matter.

FIG. 10 illustrates a method for setting up a laser system for bird control in and around an enclosure, in accordance with various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

The present subject matter provides devices, systems, and methods for unique techniques for bird control. In various embodiments, pest birds, such as sparrows, are corralled into nets for removal and relocation. Lasers can be utilized to change bird flight patterns, flush birds into mist nets for safe removal, discourage their movement to refuge locations such as ceiling rafters, discourage their entry into enclosed structures and repel them from the enclosed structures once entered, and/or discourage them from landing on or flying around the enclosed structures.

Various embodiments include customized mist-net equipment that can allow service providers to perform services to remove indoor birds without having to use lifts or ladders; while keeping their feet on the ground for safety purposes. Various embodiments include laser deterrent systems that can automatically reduce or eliminate the presence of bird in or around an enclosed structure, thereby reducing time and manpower needed for necessary bird control.

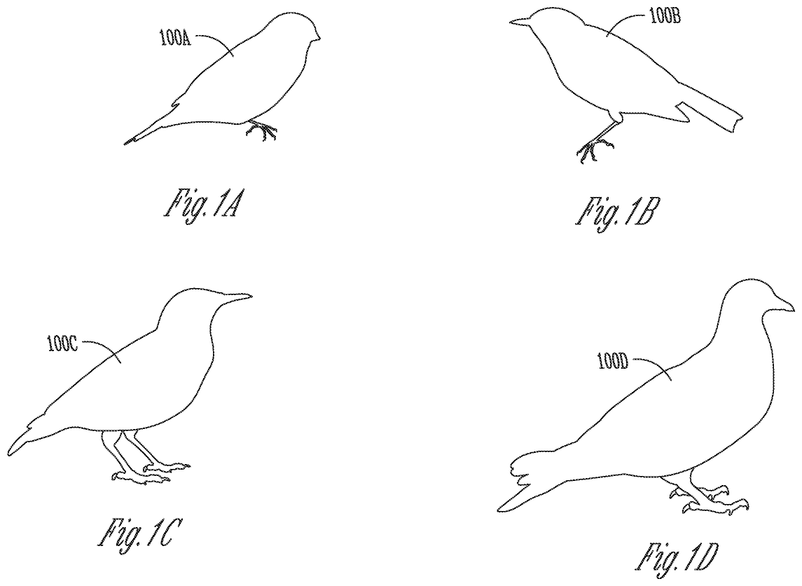

Applicable local laws and regulations concerning birds shall be understood before determining and implementing a bird control strategy. For example, in the United States, it is beneficial to check local, state, and federal laws that may prohibit certain bird control practices or require special licensing or certification. In the event a protected species enters a building, it may be necessary to contact the local U.S. Fish and Wildlife Services or Department of Natural Resources. The birds generally not protected by federal or state laws are depicted in FIGS. 1A-D: House Sparrows (Passer domesticus), such as female house sparrow 100A (FIG. 1A) and male house sparrow 100B (FIG. 1B), European Starlings (Sturnus vulgaris) 100C (FIG. 1C), and Feral Pigeons (Columbia livia) 100D (FIG. 1D).

The present subject matter provides various systems, devices, and methods for bird control in and around an enclosed structure. Various embodiments use one or more of these systems, devices, and methods to remove birds from the interior of the structure, prevent birds from the entering the interior of the structure, and/or discourage bird activities on or around the exterior of the structure.

Bird Removal from Enclosure

Removal of pest birds from large facilities may be a time-consuming endeavor. The conditions of the facility may generally favor birds, and this can dramatically affect bird removal success. Examples of such conditions include:
The quantity of birds within the facility may affect service time; in general, more birds take more time, especially when they learn that they are being pursued;
Service during hours of operation, customer levels, and product restocking may restrict the success of bird removal;
Open beam opportunities which provide for hiding and perching;
Palletized merchandise within the store construction may provide additional hiding places;
Loading dock and automatic doors may allow birds to freely enter and exit the facility;
Threatening sights and sounds may cause birds to quickly vanish within the facility;
Failed capture attempts may lead to future avoidance of control strategies;
Birds may not show interest in baited traps if established food and water sites are still available; and/or
The length of time that the birds have been in the facility and become acclimated.

Bird activity inside a facility includes three general categories: birds feeding inside a building, birds accidentally trapped inside a building, or birds roosting inside a building. Each of these categories presents challenges and will be considered separately.

Category 1—Birds feeding inside a Building: In this category, one or more birds enter to feed and/or loaf during the day. These birds do not stay overnight, but leave and roost outside the building. Likely places where this behavior occurs is in tire centers, garden centers, and loading docks that may either be open or have open doors for some period of the day. This situation can lead to harassed customers and damaged merchandise.

Category 2—Birds Accidentally Trapped inside a Building: In this category, one or more birds have found their way into a building but have not established a roost or a food source. This situation can be characterized by a bird flying in an un-patterned fashion and/or frequently visiting sky lights in an attempt to find a way out of the building. An example of this situation would be a bird that has entered a store on a grocery-type cart that has never been in the facility in the past. Birds that find their way into buildings and cannot leave can be a special situation. These birds are generally looking to leave the building. If handled early, the bird may be able to be flushed out and/or removed quickly and easily.

Category 3—Birds Roosting (Established) Inside a Building: In this category, birds roost in a building and typically do not leave. The birds may have a. nest and a source of food and water. This situation can result in a long-term interior bird infestation. This situation is any bird that lives in a building and does not leave the building. Nests will be made of materials found inside the store. The bird may not be flushed out and/or removed easily and traps and/or mist nets should be considered.

The present subject matter provides various bird control measures that can be used alone or in combination to control bird populations in a building.

### Trapping

One option for bird control is to remove indoor birds using traps, such as box traps. Box traps are a form of live trap for birds and other animals which employ a trap door that is triggered by the animal to be trapped within an enclosure. In the case of birds, the box traps can be baited with food and/or nesting material. When attempting to get the food or nesting material, the bird sets off a trap door which encloses the bird in the enclosure. Box traps often use a spring-loaded door that is set in an open state to allow a bird access to the box and its contents. The trap door is triggered by the bird, and encloses the bird in an enclosure. The enclosure can be made of wire screen or solid material, such as wood or plastic. A trapped bird can be removed from the area in which it was trapped, and the door can be opened to release the bird to the wild. Box traps may use an audible module to provide bird calls which attract a particular species of bird and no other pest bird species. For example, an audible module can be used to call out to sparrows and thereby attract them without attracting other species. Examples of audible modules and box traps include those sold by various manufacturers, such as the Sparrow Call Module for the Sparrow Trap Door from Bird Barrier (www.birdbarrier.com).

Box traps can be baited with a piece of bread, donut, or other bait, and can be placed on a solid surface or hung near where birds are known to congregate and within their line of sight. The box trap should be placed out of reach of pets and children. After a bird is captured if the lid is not lifted the bird will remain calm inside trap and will not escape. The trap can be taken outdoors, and in some cases a minimum of 10 miles from the property, and the bird can be released by opening the lid or bottom cleanout panel.

Another option for bird control is the use of cage wire traps. A cage wire trap is a wire enclosure fitted with a spring door that is triggered shut by an animal. The resulting enclosure allows the animal to be live-trapped for removal. In the case of trapping birds, the cage wire trap can be baited with food or nesting material or other objects of interest to a bird. Upon inspection of the bait, the trap door is triggered and closes on the animal. Other baits can be used, such as other birds. For example, a sparrow trap door can be turned into a repeating trap. A first sparrow is caught and falls inside the cage trap. Once inside it sings and attracts other birds. The trap door secures to the top of the cage trap with spring clips. It can be hung from the ceiling with provided cable bridle. Two “draw bridge” style patios provide safe entrance for birds and can be hinged up for transport. The inner chamber can be stocked with food and water. A sanitary metal slide-out pan keeps all food and droppings inside the trap. The trap can be easily removed by unlatching the spring clips from the slots and sliding the trap forward while closing the top of the cage to eliminate the possibility of any birds escaping.

### Flushing/Scaring

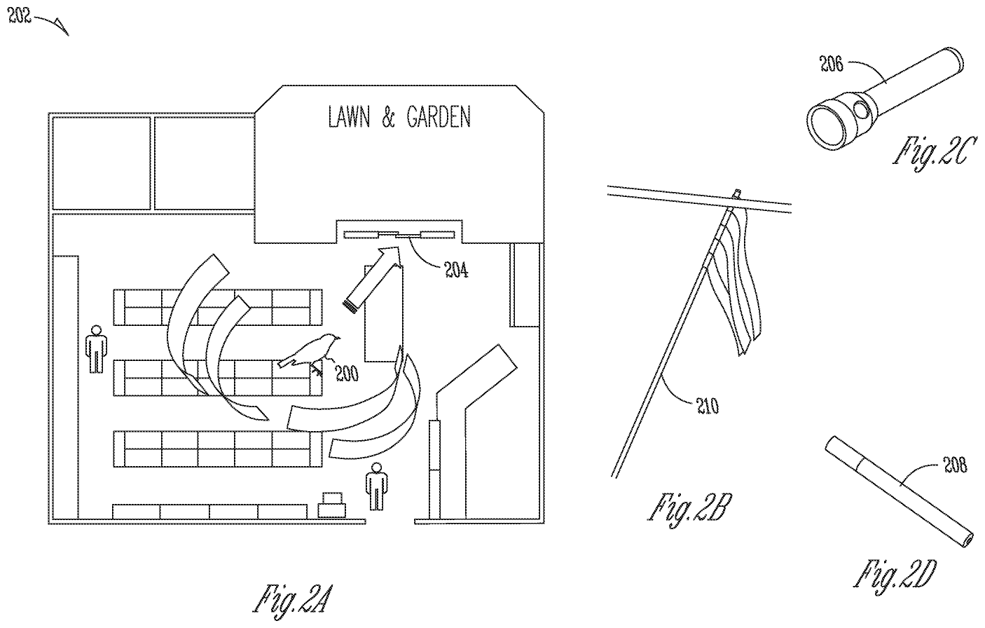

Normally, flushing is most effectively done shortly after birds have come inside and before they become acclimated and have established roost sites or food sources. This is typically within 36 to 72 hours of entering an enclosure, such as a warehouse. Steps can include one or more of the following:
Identify possible entry points. Also determine if there are any simple exit points.
If possible, turn interior lights off or down except near exit points.
FIG. 2A-D illustrate a flushing technique 202 in accordance with various embodiments. Scare tactics may be used to force or herd a bird 200 in an enclosure (FIG. 2A), such as a warehouse, to an open window or door 204 or open skylight. Good options for directing birds include, for example, flash tapes on a chase pole 210 (FIG. 2B), a strobe flashlight 206 (FIG. 2C), and a laser pointer 208 (FIG. 2D). Care should be taken not to scare the bird into hiding. To initiate movement of the bird, sound harassment (e.g. tapping metal racking) near bird can be effective.
In various embodiments, flushing can be more efficient and effective as a team activity, and hence, includes a team activity possibly utilizing store employees to herd or direct birds to exit points.
In various embodiments, persons position themselves to herd the birds to the targeted exit area (e.g. a “funnel model”).

### Mist Nets

Mist nets are extremely fine nets that can be placed across the flight paths of birds. Birds generally do not see the nets in flight, hit them, and become entangled in the loose netting. Mist netting is most effective when multiple nets are placed to reduce the population down quickly. Tactics including the trapping and flushing/scaring, as discussed above, can also be used in combination with mist nets.

In various embodiments, mist nets are rectangular in shape and available in various sizes and colors, and may be deployed using different methods. A typical rectangular size net can be 8 feet by 40 feet. Other shapes may be used without departing from the present subject matter. In various embodiments, nets employ a single color. For example, nets may be black, white, or any desired color. In various embodiments, nets can be multicolored. Examples of multicolored nets include nets that are camouflaged and or nets designed to substantially match or fit in a background. In various embodiments, the colors and length are varied to achieve an effect. For example, net colors and lengths can be varied to simulate a tunnel or other corralling or herding structure. In various embodiments, the nets have a fine nylon mesh and a plurality of strings to be tied to objects, including but not limited to rafters, girders, or beams. In various embodiments, the net is tethered, and has a very fine nylon mesh and a plurality of shelf strings. Shelf strings include cords, strings, twine, or any kind of relatively sturdy string capable of supporting the weight of the net. Such strings are often run the length of the net to support the net. In various embodiments, the plurality of shelf strings are nylon strings; however, it is understood that other types of strings may be used. In various embodiments, three or four shelf strings are used; however, it is understood that other numbers of strings may be used. In various embodiments, mesh sizes vary and ¾ inch mesh is recommended for capturing sparrows 100A, 100B, and starlings 100C; however, it is understood that other meshes may be used. In various embodiments, the net may include tethers on the corners and four shelf strings that run horizontal through the net. These thicker strands can be looped at each end and can be used to tie nets to poles or other objects. In various embodiments, the mist nets are reusable. Nets can be folded in baskets or resealable bags, or rolled in sheeting (e.g., plastic sheeting or butcher paper), rolled onto the poles, and/or stored in a case or inside a four-inch PVC pipe for storage. The PVC pipe can include a secured end cap on one side and an openable threaded cap on the other. Such approaches allow the net to be stored to avoid tangles and to enhance the ease and speed of deploying the net without tangles or complicated deployments. For example, such designs may provide for deployment of the net by separating the poles, thereby pulling the net from the bag, plastic sheeting, butcher paper, basket or other means for storing the net between uses. It is understood that other storage techniques may be applied and may be combined with the ones stated herein.

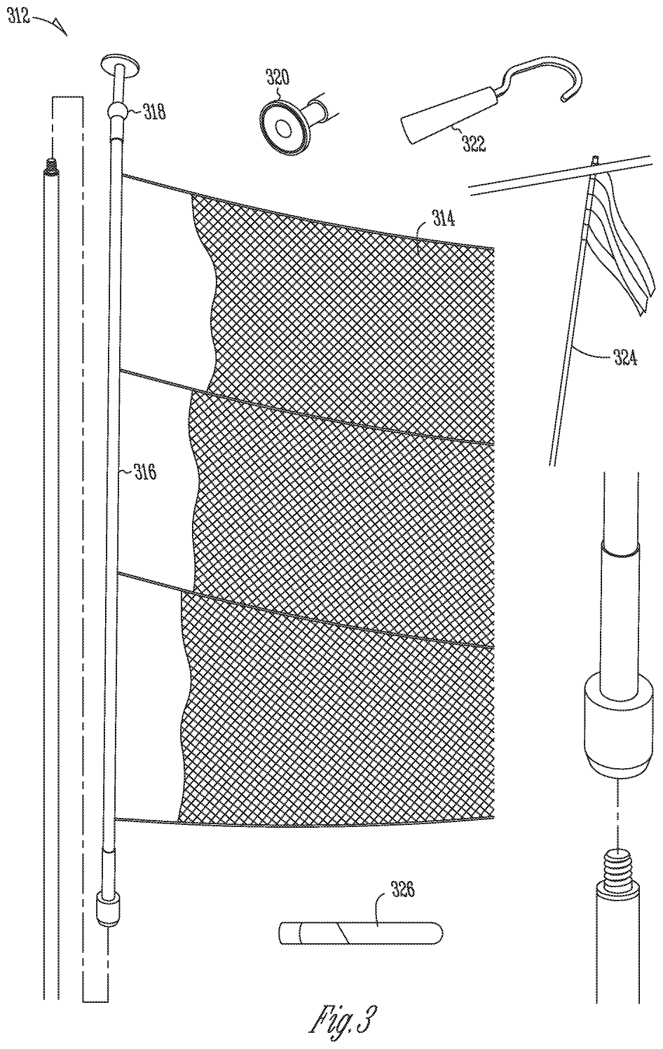

FIG. 3 illustrates a mist net system 312, in accordance with various embodiments. In the illustrated embodiments, mist net system 312 includes mist nets 314, an extension pole set 316, removable pole top extensions 318, a magnet 320, a hook attachment 322, a chase pole 324, a laser pointer 326, and a discrete carrying case and instructions. As shown in FIG. 3, extension pole set 316 can be long enough to hang mist net 324 to a ceiling or rafter and allow a user to remain standing on the ground. Magnet 320 or hook attachment 322 can provide the top of the extension pole set 316 with varied attachment devices to variable structures and surfaces.

### Laser-Mist Net System Examples

In various embodiments, lasers are used to affect bird flight patterns. The use of lasers, particularly multi-laser projectors (e.g., models micro Star and Micro Glaxian II by ADJ Products, LLC®, model EZ Laser RGFX by Chauvet®, DJ), which can produce between one to thousands of laser beams of one or more colors to corral birds into mist nets and deter movement to unwanted locations such as ceiling rafters.

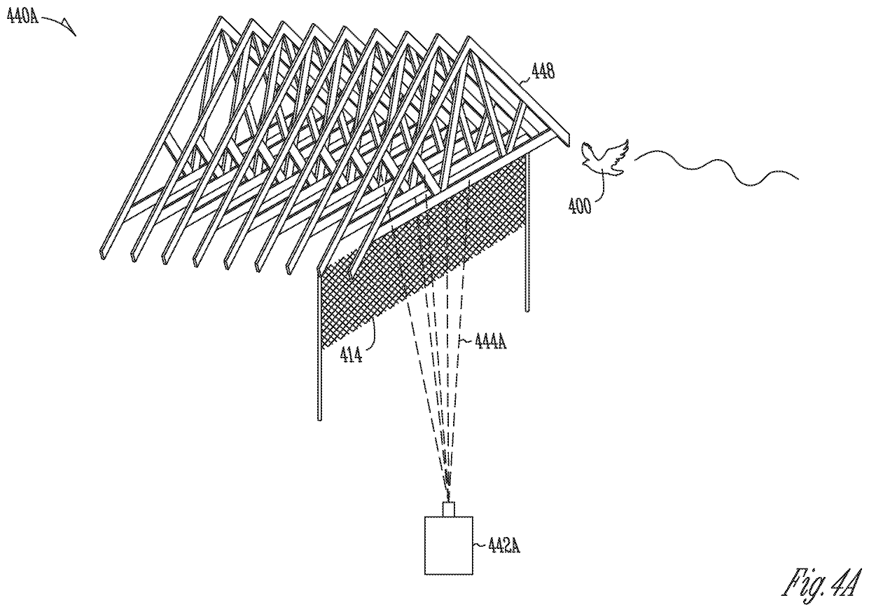

Rafters can present difficult bird trapping situations. FIGS. 4A-C illustrate various examples of laser positioning and directing in relation to bird flight patterns and rafter locations. FIG. 4A illustrates a vertical laser placement example 440A, in accordance with various embodiments of the present subject matter wherein a laser unit 442A is placed directly under a mist net 414 and under rafters 448 of an enclosure. Laser beams 444A are directed up towards net 414. The bird flight is shown at 400. Laser unit 442A can be a multi-laser projector system and can produce a plurality of colored laser beams. In an example, laser unit 442A can produce both red and green laser beams. In an example, laser unit 442A can produce more than 200 laser beams. Upon reading and understanding the present disclosure, a person of skill in the art would understand that other colors and number of beams may be employed in such applications.

FIG. 4B illustrates a laser placement example 440B where the laser system is angled from the side of the rafters, in accordance with various embodiments of the present subject matter. A laser unit 442B is placed such that laser beams 444B are directed at an angle towards rafters 448 (or other ceiling structures). Net 414 may be located to catch birds flying under the rafters as shown. The bird flight direction is shown at 400 and in some cases can be towards laser beams 444B. In various embodiments, laser unit 442B directs the beams at a 45-degree angle in relation to horizontal. Other angles can be used as well.

FIG. 4C illustrates a laser placement example 440C where the laser system points towards rafters 448 (along a ridge line) and along a path of flight of birds 400, in accordance with various embodiments of the present subject matter. A laser unit 442C can be placed such that laser beams 444C are directed at an angle towards rafters 448 (or other ceiling structures). Net 414 can be located as shown. The bird flight direction is shown at 400 and in various embodiments can be away from laser beams 444C. In various embodiments, laser unit 442C directs the beams at a 45-degree angle in relation to horizontal. Other angles can be used as well.

### Laser Bird Deterrent for Enclosure

In addition to removing birds from a building using one or more techniques discussed above, the present subject matter uses laser technology to automatically deter the birds from entering the building, staying in the building, and/or landing on or approaching the building, depending the specific areas from which bird exclusion is desired. In various embodiments, one or more laser units are deployed primarily to prevent birds from entering an enclosed structure (e.g., a retail or warehouse building) and secondarily to prevent birds from loafing, roosting, or nesting in the interior and the exterior of the enclosed structure. These laser unit(s) can be used, for example, in combination of the bird removal techniques discussed above to enhance their efficacy and/or to maintain the results of bird removal and hence reduce the frequency needed for applying these techniques, or alone as an automatic or semi-automatic bird exclusion system.

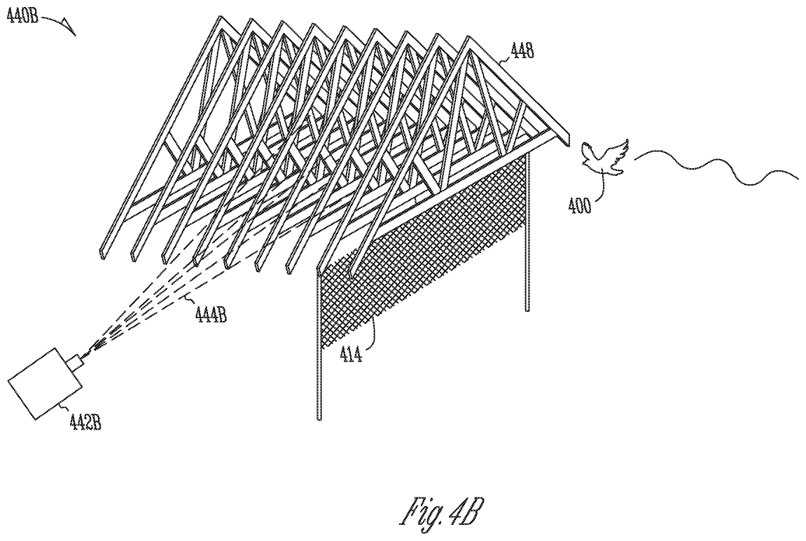

FIG. 5 illustrates a laser system 550 for bird control in and around an enclosure 530, in accordance with various embodiments. Enclosure 530 includes an interior 556, an exterior 558, and an entrance 552 that can be opened and closed using a door 554. Enclosure 530 can represent, for example, a retail or warehouse building with one or more entrances through which birds may fly and/or walk through, and entrance 552 can represent a dock entrance such as the entrance of a receiving and shipping dock, with door 554 being a dock door. While entrance 552 can represent a primary entry point for birds, enclosure 530 can includes other door(s) and/or window(s) that can be additional entry point(s) for birds. FIG. 5 shows enclosure 530 with one entrance that is to be protected by laser system 550 for illustrative but not restrictive purposes. The technique for bird control related to entrance 552 as discussed below can be applied to any entrance of an enclosure that can be an entry point for bird when being open, regardless of the number and types of entrances the enclosure has. Depending on the position of door 554, states of entrance 552 can include open and closed. Being open can include being partially open (e.g., an extent of opening sufficient for birds to fly and/or walk through).

Laser system 550 can include one or more laser units each placed in interior 556 or exterior 558. In various embodiments, laser system includes at least one laser unit positioned to deter birds from entering interior 556 through entrance 552, and can one or more additional laser units positioned to deter birds from loafing, roosting, or nesting in interior 556 and/or exterior 558.

For illustrating how laser unit(s) can be deployed for bird control, four laser units 542A-D of laser system 550 are shown in FIG. 5 by way of example, but not by way of restriction. Laser unit 542A is positioned in interior 556 to project one or more laser beams 544A to an area around entrance 552 (e.g., an area primarily in interior 556 adjacent entrance 552) for deterring birds from entering interior 556 through entrance 552. Laser unit 542B is positioned in exterior 558 to project one or more laser beams 544B to another area around entrance 552 (e.g., an area primarily in exterior 558 adjacent entrance 552), for deterring birds from entering interior 556 through entrance 552 and/or reducing presence of birds in exterior 558, particularly in the area near entrance 552. Laser unit 542C is positioned in interior 556 to project one or more laser beams 544C to an area in interior 556 to repel birds (already inside enclosure 530) from that area. This can include deterring birds from flying towards and/or landing on a structure in interior 556 that can become a hiding place for the birds. Laser unit 542D is positioned in exterior 558 to project one or more laser beams 544D to an area in exterior 558 to repel birds from that area. This may include discouraging birds from flying towards and/or landing on enclosure 530. Reduced presence of bird in exterior 558 can also reduce the number of birds that may attempt to enter enclosure 530.

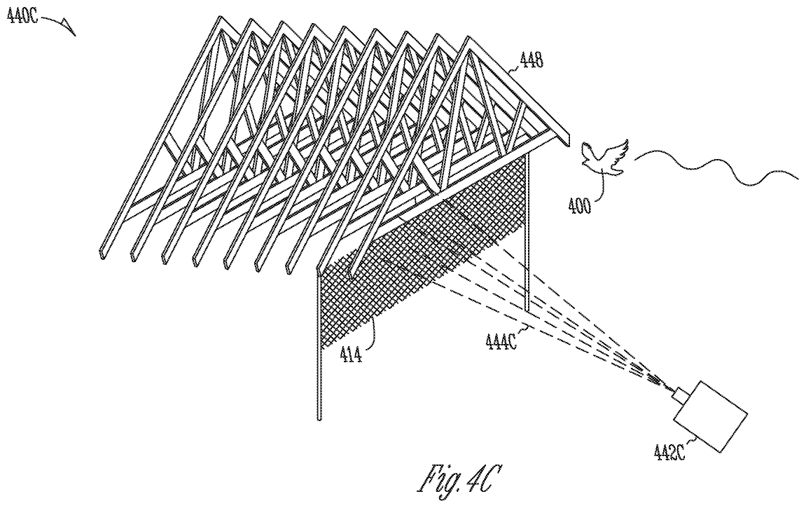

FIG. 6 illustrates a laser unit 642 for in a laser system for bird control, such as laser system 550, in accordance with various embodiments. Laser unit 642 can also be used in examples 440A-C as discussed above with reference to FIGS. 4A-C. Laser unit 642 includes a laser projector 660 that can project one or more laser beams (e.g., one of laser beams 444A-C and 544A-D) and a controller 662 that can control the operations of laser unit 642, including the projection of the one or more laser beams. In various embodiments, controller 662 can be configured (e.g., programmed) to control an activation, a direction, and/or a pattern of the projection of the one or more laser beams. Laser unit 642 can be a single device integrating laser projector 660 and controller 662 housed in a single chassis, or include laser projector 660 and controller 662 being separate devices communicatively coupled to each other via a wired or wireless connection.

Laser projector 660 can be a device capable of projecting a single laser beam or a device capable of projecting multiple laser beams. Birds are known to react to visual stimuli including laser beams by starting to fly or changing direction of flying. The one or more laser beams projected from laser projector 660 have a wavelength or a range of wavelengths selected within a range of wavelengths known to be visible to birds. In various embodiments, laser projector 660 projects one or more laser beams of a single color. In various other embodiments, laser projector 660 projects one or more laser beams of multiple colors. It has been learned that many birds are primarily sensitive to the color green and, to a lesser degree, also sensitive to the color red. Therefore, in various embodiments, laser projector 660 projects one or more green laser beams or one or more red and green laser beams. Other colors can also be made available from laser projector 960 if found effective in deterring certain types of birds.

Controller 662 can control the projection of the one or more laser beams from laser projector 660 to cause desirable movements of birds while preventing the birds from becoming acclimated to the one or more laser beams. This can be achieved by any one or any combination of intermittent activation of laser projector 660, changing the direction of the projection, and changing the pattern of the projection. In various embodiments, a protocol for controlling the projection of the one or more laser beams can be designed and adjusted based on the reaction of birds learned during the use of laser unit 642. The protocol can specify parameters controlling a sequence of activation, direction, and/or pattern of the projection of the one or more laser beams.

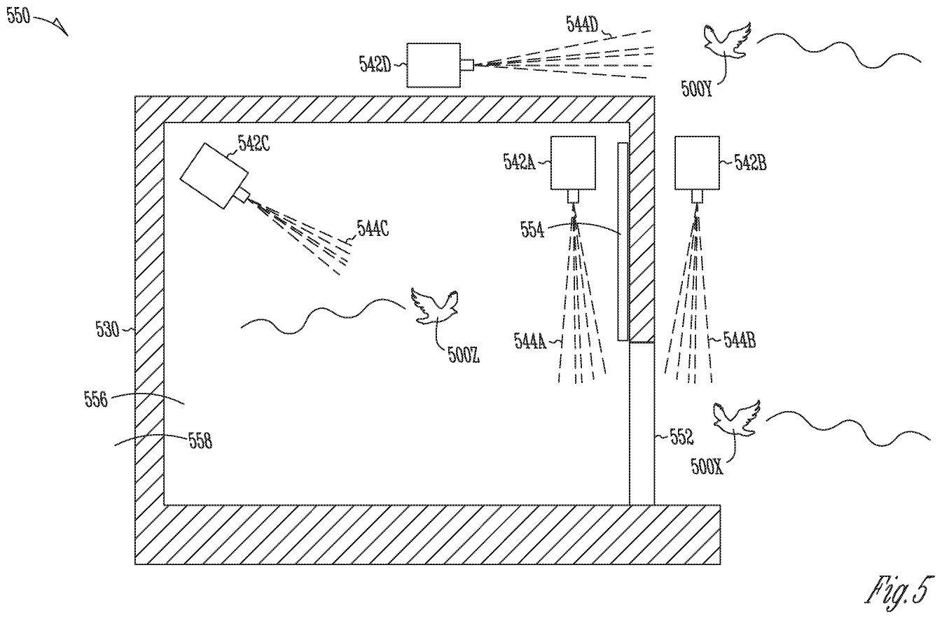

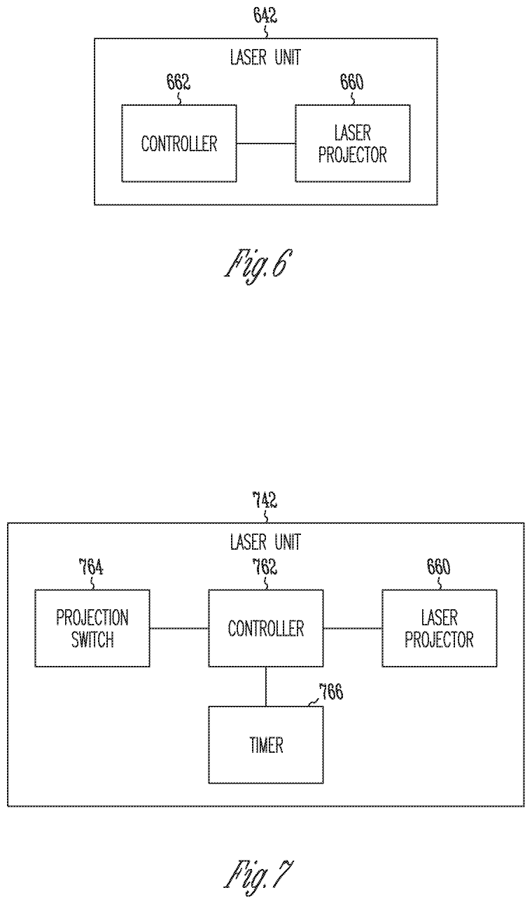

To control the activation of the projection of the one or more laser beams, controller 662 can activate laser projector 660 to project the one or more laser beams and deactivate laser projector 660 to stop protecting the one or more laser beams on a specified schedule (e.g., periodically) and/or in response to one or more commands and/or signals. In various embodiments, controller 662 can receive one or more signals indicative a need for deterring birds (e.g., anticipated and/or detected presence of one or more birds) and activate and deactivate laser projector 660 using the received signal(s), as further discussed below with reference to FIGS. 7 and 8.

To control the direction of the projection of the one or more laser beams, controller 662 can dynamically change of the direction of the projection, for example by dynamically changing the orientation of laser projector 960. In various embodiments, the direction of the projection is controlled for efficacy in deterring birds while ensuring safety, for example by preventing any of the one or more laser beams from being projected toward human eyes.

To control the pattern of the projection of the one or more laser beams, controller 662 can dynamically change the number of laser beams being projected, the color of the one or more laser beams, the spatial characteristics of the pattern, and/or the temporal characteristics of the pattern, The spatial characteristics of the pattern can include, for example, the direction of each laser beam projected. The temporal characteristics of the pattern can include, for example, speed of the change of the number of laser beams, speed and/or order of the change of the color of the one or more laser beams, speed of the change of the spatial characteristics of the pattern, and/or the order of the spatial characteristics of the pattern being displayed (e.g., a predetermined, random, or pseudo-random order).

FIG. 7 illustrates a laser unit 742 for use in a laser system for bird control, such as laser system 550, in accordance with various embodiments. Laser unit 742 can represent a further embodiment of laser unit 642, and can include laser projector 660, a controller 762, a projection switch 764, and optionally a timer 766. Controller 762 can represent a further embodiment of controller 662 and can perform all the functions of controller 662 as discussed above, and can control the projection of the one or more laser beams from laser projector 660 using a switch signal that indicates a need for deterring or expelling birds. In various embodiments in which laser unit is used for bird control for an enclosure (such as enclosure 530), the switch signal is indicative of the state of an entrance of the enclosure (such as enclosure 552). Laser unit 742 can be a single device integrating laser projector 660, controller 762, and projection switch 764 housed in a single chassis, or include laser projector 660, controller 762, and projection switch 764 in two or more separate devices communicatively coupled to each other via one or more wired and/or wireless connections.

Projection switch 764 can be driven by the state of the entrance and can produce a switch signal indicative of the state of the entrance. Examples of projection switch 764 can include an entrance switch that opens and closes the entrance and/or a sensor (e.g., an optical sensor or a motion sensor) that senses the state of the entrance. The state of the entrance can be open or closed, or can indicate an opening or closing of the entrance. An open state can include any partial opening of the entrance that may allow birds to move through. Controller 742 can control laser projector 660 to project the one or more laser beams using the switch signal. For example, controller 762 can control laser projector 660 to project the one or more laser beams according to a first protocol when the entrance is open (or in response to an opening of the entrance) and control laser projector 660 to project the one or more laser beams according to a second protocol when the entrance is open (or in response to an opening of the entrance). The first protocol can differ from the second protocol in the activation, the direction, and/or the pattern of the projection of the one or more laser beams. In one embodiment, controller 762 can activate laser projector 660 to project the one or more laser beams when the entrance is open (or in response to an opening of the entrance) and to deactivated laser projector 660 to stop protecting the one or more laser beams when the at least one entrance is closed (or in response to a closing of the entrance).

Laser unit 742 can be used as one or more of laser units 542A-D of laser system 550, when any or all of laser units 542A-D are sought to be driven by the state of entrance 552. For example, laser unit 742 can be used as laser unit 542A when its primary purpose is to deter birds from entering interior 556 when entrance 552 is open. Laser unit 742 can be used as laser unit 542B when its primary purpose is also to deter birds from entering interior 556 when entrance 552 is open. Laser unit 742 can be used as laser unit 542C when its primary purpose is to expel birds from interior 556 by guiding to move out through entrance 552 when it is open. Laser unit 742 can be used as laser unit 542D when its primary purpose is to keep birds away from exterior 558 when entrance 552 is open, thereby reducing the number of birds that may be able to enter interior 556 through entrance 552. In one embodiment, projection switch 764 can be enabled or disabled, depending on whether laser unit 742 is to be driven by the state of an entrance. Thus, laser unit 742 can be used as each of laser units 542A-D of laser system 550, with projection switch 764 being enabled for any of laser units 542A-D that is to be driven by the state of entrance 552.

In some embodiments, laser unit 742 further includes timer 766, and controller 762 can control the projection of the one or more laser beams from laser projector 660 using the switch signal and one or more timing signals generated by timer 766. Example of the one or more timing signals include minimum and/or maximum time intervals and a clock signal. In one embodiment, timer 766 is used in conjunction with projection switch 764 to control minimum and/or maximum amount of time for which the one or more laser beams should be projected from laser projector 660. For example, controller 762 can control laser projector 660 to project the one or more laser beams for a specified minimum time interval even if the entrance is closed before the minimal time interval expires, and/or can control laser projector 660 to stop the projection of the one or more laser beams upon expiration of a specified maximum time interval even if the entrance is still open. In another embodiment, timer 766 is used in conjunction with projection switch 764 to control when (e.g., days and/or times of each day) the switch signal from projection switch 1064 should be used to control the projection of the one or more laser beams from laser projector 660. This allows laser unit 742 to be driven by the state of the entrance only during certain period(s) of time.

FIG. 8 illustrates a laser unit 842 for use in a laser system for bird control, such as laser system 550, in accordance with various embodiments. Laser unit 842 can represent a further embodiment of laser unit 642 or laser unit 742, and can include laser projector 660, a controller 862, projection switch 764, a bird sensor 868, and optionally timer 766. Controller 862 can represent a further embodiment of controller 762 and can perform all the functions of controller 762 as discussed above, and can control the projection of the one or more laser beams from laser projector 660 using a sensor signal indicates detection of presence of one or more birds in a vicinity of laser unit 842. Laser unit 842 can be a single device integrating laser projector 660, controller 862, projection switch 764, and bird sensor 868 housed in a single chassis, or include projector 660, controller 862, projection switch 764, and bird sensor 868 in two or more separate devices communicatively coupled to each other via one or more wired and/or wireless connections.

Bird sensor 868 can detect the presence of one or more birds and produce the sensor signal. Examples of bird sensor 868 include a motion sensor that can detect movement of birds, a camera that can detect birds by image processing, and a radar that can detect location and moving direction of birds. Bird sensor can be positioned to detect birds that are in or around an area protected by laser unit 842.

Controller 862 can control laser projector 660 to project the one or more laser beams using the sensor signal. For example, controller 862 can control laser projector 660 to project the one or more laser beams according to a first protocol when the entrance is open (or in response to an opening of the entrance) and/or when the presence of one or more birds is detected and control laser projector 660 to project the one or more laser beams according to a second protocol when the entrance is open (or in response to an opening of the entrance) and/or when the presence of one or more birds is not detected. The first protocol can differ from the second protocol in the activation, the direction, and/or the pattern of the projection of the one or more laser beams. In one embodiment, controller 742 can activate laser projector 660 to project the one or more laser beams when the entrance is open (or in response to an opening of the entrance) and/or when the presence of one or more birds is detected and to deactivated laser projector 660 to stop protecting the one or more laser beams when the at least one entrance is closed (or in response to a closing of the entrance) and/or when the presence of one or more birds is not detected.

Laser unit 842 can be used as one or more of laser units 542A-D of laser system 550, when any or all of laser units 542A-D are sought to be driven by the state of entrance 552 as well as presence of birds. For example, laser unit 842 can be used as laser unit 542A when its primary purpose is to deter birds from entering interior 556 when entrance 552 is open. Laser unit 842 can be used as laser unit 542B when its primary purpose is also to deter birds from entering interior 556 when entrance 552 is open. Laser unit 842 can be used as laser unit 542C when its primary purpose is to expel birds from interior 556 by guiding to move out through entrance 552 when it is open. Laser unit 842 can be used as laser unit 542D when its primary purpose is to keep birds away from exterior 558 when entrance 552 is open, thereby reducing the number of birds that may be able to enter interior 556 through entrance 552. Use of the sensor signal to drive laser projector 660 allows the one or more laser beams to be projected when birds are likely present, such that laser beams do not become a nuisance or safety concern themselves. In one embodiment, each of projection switch 764 and bird sensor 868 can be enabled or disabled, depending on whether laser unit 842 is to be driven by the state of an entrance and/or the presence of birds. Thus, laser unit 842 can be used as each of laser units 542A-D of laser system 550, with projection switch 764 being enabled for any of laser units 542A-D that is to be driven by the state of entrance 552 and bird sensor 868 being enabled for any of laser units 542A-D that is to be driven by the presence of birds.

In some embodiments, laser unit 842 further includes timer 766, and controller 862 can control the projection of the one or more laser beams from laser projector 660 using the switch signal and/or the sensor signal in conjunction with the one or more timing signals generated by timer 766. Example of the one or more timing signals include minimum and/or maximum time intervals and a clock signal. In one embodiment, timer 766 is used in conjunction with projection switch 764 and/or bird sensor 868 to control minimum and/or maximum amount of time for which the one or more laser beams should be projected from laser projector 660. For example, controller 862 can control laser projector 660 to project the one or more laser beams for a specified minimum time interval even if the entrance is closed and/or the presence of one or more birds is not detected before the minimal time interval expires, and/or can control laser projector 660 to stop the projection of the one or more laser beams upon expiration of a specified maximum time interval even if the entrance is still open and/or the presence of one or more birds is still detected. In another embodiment, timer 766 is used in conjunction with projection switch 764 and/or bird sensor 868 to control when (e.g., days and/or times of each day) the switch signal from projection switch 764 and/or the sensor signal from bird sensor 868 should be used to control the projection of the one or more laser beams from laser projector 660. This allows laser unit 842 to be driven by the state of the entrance and/or the presence of one or more birds only during certain period(s) of time.

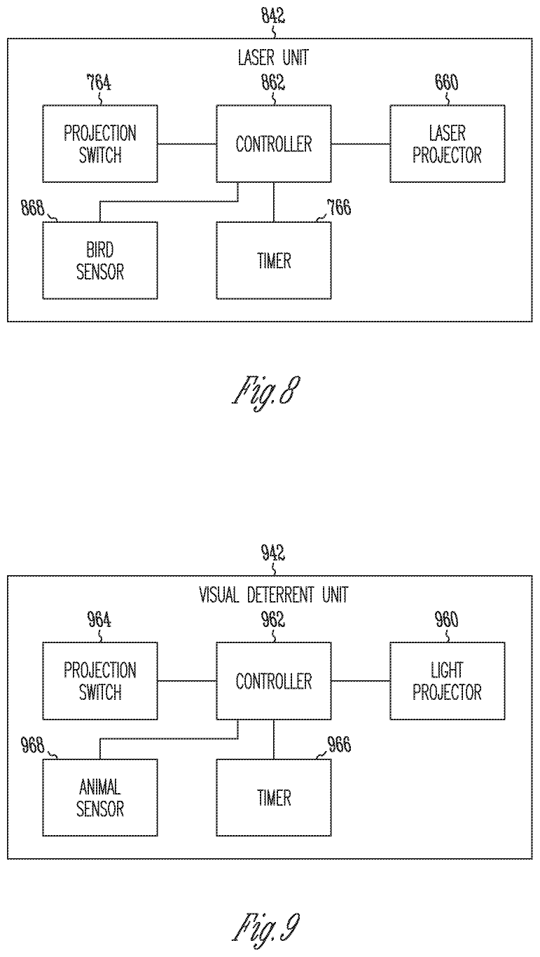

While various embodiments use a laser system including laser units for bird control, the present subject matter is neither limited to using laser technology nor limited to bird control. FIG. 9 illustrates a visual deterrent unit 942 for use in a system for animal control, in accordance with various embodiments. The system for animal control can be similar to system 550, with one or more visual deterrent units 942 positioned according to locations and movements of the target animals to be controlled (e.g., rodents). Visual deterrent unit 942 can include a light projector 960, a controller 962, and optionally a projection switch 964, an animal sensor 968, or a timer 966.

Light projector 960 can project one or more light beams having characteristics (e.g., intensity and wavelength) suitable for deterring the type(s) of target animals. One example of light projector 960 includes laser projector 660 as discussed above. Another example of light projector 960 includes laser projector 660 with the characteristics (e.g., intensity and wavelength) of the laser tailored for deterring the target animals. Other examples of light projector 960 include a device that projects one or more light beams from one or more light-emitting diodes (LEDs), a device that projects one or more ultraviolet (UV) light beams, a liquid crystal display (LCD) projector that projects an optical pattern or image, and devices that project one or more light beams or optical images of any type that is visible to the target animals.

Controller 962 can control the projection of the one or more light beams from light projector 960 to cause desirable movements of the target animals while preventing the target animals from becoming acclimated to the one or more light beams. Controller 962 can be configured (e.g., programmed) to perform the same functions of controller 662, with the activation, direction, and/or pattern of the projection of the one or more light beams controlled in accordance of the characteristics of the target animals. In various embodiments, a protocol for controlling the projection of the one or more light beams can be designed for each type of target animals with distinctive visual and behavioral characteristics, and can be adjusted based on the reaction of that type of target animals learned during the use of visual deterrent unit 942. The protocol can specify parameters controlling a sequence of activation, direction, and/or pattern of the projection of the one or more light beams.

When the purposes of animal control include preventing the target animal from entering an enclosure through an entrance, visual deterrent unit 942 with projection switch 964 included and enabled can be used. Projection switch 964 can be driven by the state of the entrance and can produce a switch signal indicative of the state of the entrance. Controller 962 can control light projector 960 to project the one or more light beams using the switch signal. Projection switch 964 can be the same as projection switch 764 as discussed above, and controller 962 can use the switch signal in the same way as how controller 762 uses the switch signal produced by projection switch 764, except that the activation, direction, and/or pattern of the projection of the one or more light beams can be adjusted for the target animals when deemed necessary or desirable.

When it is desirable to project the one or more light beams from light projector 960 only when one or more target animals are present in or near the area for animal control, visual deterrent unit 942 with animal sensor 968 included and enabled can be used. Animal sensor 968 can detect the presence of one or more target animal and produce a sensor signal in response to each detection. Controller 962 can control light projector 960 to project the one or more light beams using the sensor signal. Controller 962 can use the sensor signal in the same way as how controller 962 uses the sensor signal produced by bird sensor 868, except that the activation, direction, and/or pattern of the projection of the one or more light beams can be adjusted for the target animals when deemed necessary or desirable.

In various embodiments, visual deterrent unit 942 includes projection switch 964 and bird sensor 968 that can be individually enabled and disabled. Controller 962 can control light projector 960 to project the one or more light beams using the switch signal and/or the sensor signal.

In some embodiments, visual deterrent unit 942 further includes timer 966, and controller 962 can control the projection of the one or more laser beams from light projector 960 using the switch signal and/or the sensor signal in conjunction with the one or more timing signals generated by timer 966. Example of the one or more timing signals include minimum and/or maximum time intervals and a clock signal. In one embodiment, timer 966 is used in conjunction with projection switch 964 and/or animal sensor 968 to control minimum and/or maximum amount of time for which the one or more light beams should be projected from light projector 960. For example, controller 962 can control light projector 960 to project the one or more light beams for a specified minimum time interval even if the entrance is closed and/or no presence of animal is detected before the minimal time interval expires, and/or can control light projector 960 to stop the projection of the one or more light beams upon expiration of a specified maximum time interval even if the entrance is still open and/or the presence of one or more animals is still detected. In another embodiment, timer 966 is used in conjunction with projection switch 964 and/or animal sensor 968 to control when (e.g., days and/or times of each day) the switch signal from projection switch 964 and/or the sensor signal from animal sensor 968 should be used to control the projection of the one or more light beams from laser projector 960. This allows visual deterrent unit 942 to be driven by the state of the entrance and/or the presence of one or more animals only during certain period(s) of time.

Various embodiments can use the various laser units and/or visual deterrent units discussed above in combination with other deterrents, such as sonic and/or ultrasonic repellent devices producing bird alarm calls, predator sounds, etc. The laser and/or light units discussed above can be used alone, or can be used in combination with other bird control techniques to create a comprehensive bird control plan for an enclosed structure.

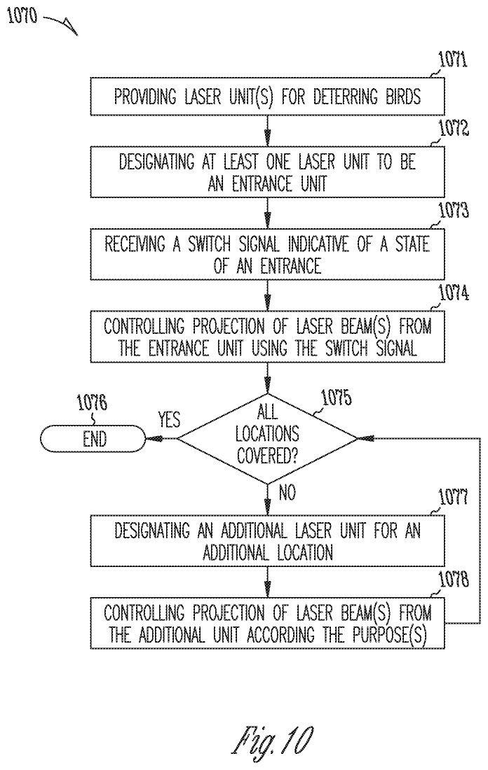

FIG. 10 illustrates a method 1070 for setting up a laser system for bird control in and around an enclosure, in accordance with various embodiments of the present subject matter. Method 1070 uses one or more laser units. Such one or more laser units can each include, but are not limited to, one of the laser units discussed above (e.g., laser units 442A-C, 542A-D, 642, 742, and 842). The enclosure has one or more entrances.

At 1071, one or more laser units are provided for deterring birds. The one or more laser units can each project one or more laser beams.

At 1072, at least one laser unit is designated to be an entrance unit for protecting an entrance of the enclosure, including preventing birds from entering the enclosure through that entrance. The entrance unit can be positioned in the interior of the enclosure to project the one or more laser beams to an area around the protected entrance. The entrance unit can also be positioned in the exterior of the enclosure to project the one or more laser beams to an area around the protected entrance. In one embodiment, two laser units are designated as entrance units, with in positioned in the interior and the other positioned in the exterior. Various embodiments my designate multiple entrance units or protect each of two or more entrances of the enclosure that are likely entry points for birds.

At 1073, a switch signal indicative of a state of the protected entrance is received. The state of the protected entrance can be open (including partially open) or closed. The switch signal can be produced, for example, using an entrance switch that opens and closes the protected entrance or an entrance motion sensor that senses the state of the protected entrance.

At 1074, the projection of the one or more laser beams from the entrance unit is controlled using the switch signal, This can include controlling an activation, a direction, and/or a pattern of the projection of the one or more laser beams from the entrance unit using the switch signal. In various embodiments, the projection of the one or more laser beams from the entrance unit, as well as from the other laser unit(s) if any, is controlled to cause desirable movements of birds while preventing the birds from becoming acclimated to the one or more laser beams. This can include activating the entrance unit to project the one or more laser beams in response to an opening of the protected entrance as indicated by the switch signal, and deactivating the entrance unit to stop projecting the one or more laser beams in response to a closing of the protected entrance as indicated by the switch signal. This can also include controlling the projection of the one or more laser beams from the entrance unit using the switch signal. In various embodiments, controlling the projection of the one or more laser beams from the entrance unit, as well as from the other laser unit(s) if any, can include dynamically changing the direction of the projection and/or dynamically changing the pattern of the projection. When desired, the projection of the one or more laser beams from the entrance unit, as well as from the other laser unit(s) if any, can also be controlled using a sensor signal produced by a bird sensor that detects presence of one or more birds in or near an area of bird control, in addition to or in place of using the switch signal. In various embodiments, a clock signal indicative of days and times of the day can be generated, and the activation, the direction, and/or the pattern of the projection of the one or more laser beams from the entrance unit can be controlled using the switch signal and the clock signal. In various embodiments, a minimum time interval and/or a maximum time interval can be generated, the entrance unit can be deactivated to stop projecting the one or more laser beams upon expiration of the minimum time interval when the protected entrance is closed before the expiration of the minimum time interval and/or upon expiration of the maximum time interval when the protected entrance is not closed before the expiration of the maximum time interval.

At 1075, whether all the locations where birds are to be excluded are covered is determined. The locations can be determined, for example, based on presence and movements of birds predicted from relevant knowledge and experience and/or observed from the interior and the exterior of the enclosure. If all the locations are covered at 1075, the setup of the laser system is completed at 1076.

If one or more locations are not covered at 1075, an additional laser unit is designated for an additional location at 1077. The additional laser unit can be another entrance unit, an interior unit positioned in the interior to project the one or more laser beams to an area in the exterior to repel birds from that area, or an exterior unit positioned in the exterior to project the one or more laser beams to an area in the exterior to repel birds from that area.

At 1078, the projection of the one or more laser beams from the additional unit is controlled according one or more purposes of the additional unit, such as preventing birds from entering an entrance, repelling birds from the interior, and/or deterring birds from landing or flying around the exterior. For example, the projection of the one or more laser beams may be controlled based on whether an entrance is open when the purposes of the additional unit is to prevent birds from entering the interior through the entrance, to encourage birds already in the interior to move out through the entrance, or to keep bird away from an area in the exterior around the entrance when the entrance is open. The projection of the one or more laser beams may be controlled based on whether one or more birds are detected in or around an area to be protected by the additional unit.

In various embodiments, the laser units discussed in this document can be used alone or in combination with other bird deterrents (e.g., optical, sonic, chemical, and/or mechanical deterrents) installed inside the enclosure to repel birds from the enclosure and/or installed near an entrance of the enclosure to prevent birds from entering the enclosure. The entrance can include any identified entry point allowing birds to enter the enclosure, including but not limited to doors and windows. Additionally, a switch or sensor for opening and closing each entrance can be made bird-proof by preventing them from being triggered by bird movements.

In various embodiments, the devices, systems, and methods discussed in this document can be used alone or in combination with other devices, systems, and/or methods for bird control. Examples of such other devices, systems, and methods include those discussed in U.S. Pat. No. 10,709,128, entitled “METHOD AND APPARATUS FOR BIRD CONTROL”, assigned to Ecolab USA, Inc., which is incorporated herein by reference in its entirety.

Some non-limiting examples (Examples 1-25) of the present subject matter are provided as follows:

In Example 1, an apparatus for excluding birds from an enclosure having an entrance may include a laser projector and a controller. The laser projector may be configured to project one or more laser beams. The controller may be configured to receive a switch signal indicating a state of the entrance and to control at least one of an activation, a direction, or a pattern of the projection of the one or more laser beams using the switch signal.

In Example 2, the subject matter of Example 1 may optionally be configured to further include a projection switch coupled to the controller and configured to produce the switch signal. The switch signal is indicative at least an opening of the entrance and a closing of the entrance.

In Example 3, the subject matter of Example 2 may optionally be configured such that the projection switch includes an entrance switch configured to open and to close the entrance.

In Example 4, the subject matter of any one or any combination of Examples 1 and 2 may optionally be configured such that the projection switch includes a motion sensor configured to sense the state of the entrance.

In Example 5, the subject matter of any one or any combination of Examples 2 to 4 may optionally be configured such that the controller is configured to activate the laser projector to project the one or more laser beams in response to the switch signal indicating the opening of the entrance and to deactivate the laser projector to stop protecting the one or more laser beams in response to the switch signal indicating the closing of the entrance.

In Example 6, the subject matter of any one or any combination of Examples 1 to 5 may optionally be configured to further include a timer configured to generate at least one of a minimum time interval and a maximum time interval, and such that the controller is configured to perform at least one of activating the laser projector to project the one or more laser beams for at least the minimum time interval or deactivating the laser projector to stop protecting the one or more laser beams upon expiration of the maximum time interval.

In Example 7, the subject matter of any one or any combination of Examples 1 to 6 may optionally be configured such that the controller is programmable for causing the laser projector to dynamically change at least one of the direction or the pattern of projection of the multiple laser beams when the laser projector is activated.

In Example 8, a system for deterring birds in and around an enclosure having one or more entrances may include multiple laser units each including a laser projector and a controller. The laser projector may be configured to project one or more laser beams. The controller may be configured to control at least one of an activation, a direction, or a pattern of the projection of the one or more laser beams. The multiple laser units may include an entrance unit. The controller of the entrance unit may be configured to receive a switch signal indicative of a state of at least one entrance of the one or more entrances and to control the at least one of the activation, the direction, or the pattern of the projection of the one or more laser beams from the laser projector of the entrance unit using the switch signal.

In Example 9, the subject matter of Example 8 may optionally be configured to further include a projection switch coupled to the controller of the entrance unit and configured to produce the switch signal, and such that the controller of the entrance unit is configured to control the projection of the one or more laser beams for preventing the birds from entering the enclosure through the at least one entrance.

In Example 10, the subject matter of Example 9 may optionally be configured such that the controller is configured to activate the laser projector of the entrance unit to project the one or more laser beams when the switch signal indicates that the at least one entrance is open and to deactivate the laser projector of the entrance unit to stop projecting the one or more laser beams when the switch signal indicates that the at least one entrance is closed.

In Example 11, the subject matter of any one or any combination of Examples 8 to 10 may optionally be configured such that the controller is configured to cause the laser projector of the entrance unit to dynamically change at least one of the direction or the pattern of projection of the one or more laser beams when the laser projector of the entrance unit is activated.

In Example 12, the subject matter of any one or any combination of Examples 8 to 11 may optionally be configured such that the multiple laser units further includes a sensor-driven unit and a bird sensor communicatively coupled to the controller of the sensor-driven unit, the bird sensor is configured to sense presence of one or more birds and to produce a sensor signal indicative of the presence of the one or more birds, and the controller of the sensor-driven unit is configured to control the at least one of the activation, the direction, or the pattern of the projection of the one or more laser beams from the laser projector of the entrance unit using the sensor signal.

In Example 13, the subject matter of any one or any combination of Examples 8 to 12 may optionally be configured such that at least one laser unit of the multiple laser units further includes a timer configured to generate one or more timing signals, and the controller of the at least one laser unit is configured to control the at least one of the activation, the direction, or the pattern of the projection of the one or more laser beams using the one or more timing signals.

In Example 14, a method for bird control for an enclosure having an exterior, an interior, and one or more entrances is provided. The method may include providing one or more laser units each configured to project one or more laser beams, designating at least one of the one or more laser units to be an entrance unit for preventing birds from entering the enclosure through at least one entrance of the one or more entrances, receiving a switch signal indicative of a state of the at least one entrance, and controlling at least one of an activation, a direction, or a pattern of the projection of the one or more laser beams from the entrance unit using the switch signal.

In Example 15, the subject matter of Example 14 may optionally include generating a clock signal indicative of days and times of the day and controlling the at least one of the activation, the direction, or the pattern of the projection of the one or more laser beams from the entrance unit using the switch signal and the clock signal.

In Example 16, the subject matter of controlling the at least one of the activation, the direction, or the pattern of the projection of the one or more laser beams from the entrance unit using the switch signal as found in any one or any combination of Examples 14 and 15 may optionally include activating the entrance unit to project the one or more laser beams in response to an opening of the at least one entrance as indicated by the switch signal and deactivating the entrance unit to stop projecting the one or more laser beams in response to a closing of the at least one entrance as indicated by the switch signal.

In Example 17, the subject matter of any one or any combination of Examples 14 to 16 may optionally further include generating a minimum time interval and deactivating the entrance unit to stop projecting the one or more laser beams upon expiration of the minimum time interval when the closing of the at least one entrance is indicated before the expiration of the minimum time interval.

In Example 18, the subject matter of any one or any combination of Examples 14 to 17 may optionally further include generating a maximum time interval and deactivating the entrance unit to stop projecting the one or more laser beams upon expiration of the maximum time interval when the closing of the at least one entrance is not indicated before the expiration of the maximum time interval.

In Example 19, the subject matter of any one or any combination of Examples 14 to 18 may optionally further include positioning the entrance unit in the interior to project the one or more laser beams to an area around the at least one entrance.

In Example 20, the subject matter of any one or any combination of Examples 14 to 18 may optionally further include positioning the entrance unit in the exterior to project the one or more laser beams to an area around the at least one entrance.

In Example 21, the subject matter of any one or any combination of Examples 14 to 20 may optionally further include controlling the projection of the one or more laser beams from each laser unit of the one or more laser units to cause desirable movements of birds while preventing the birds from becoming acclimated to the one or more laser beams.

In Example 22, the subject matter of controlling the projection of the one or more laser beams from each laser unit of the one or more laser units as found in Example 21 may optionally include at least one of dynamically changing the direction of the projection or dynamically changing the pattern of the projection.

In Example 23, the subject flatter of controlling the projection of the one or more laser beams from each laser unit of the one or more laser units as found in any one or any combination of Examples 21 and 22 may optionally include detecting presence of birds using a motion sensor communicatively coupled to the each laser unit and activating the each laser unit to project the one or more laser beams for a period of time in response to each detection of the presence of the birds.

In Example 24, the subject matter of any one or any combination of Examples 21 to 23 may optionally further include positioning at least one interior unit of the one or more laser units in the interior to project the one or more laser beams to an area in the interior to repel birds from that area.

In Example 25, the subject matter of any one or any combination of Examples 21 to 24 may optionally further include positioning at least one exterior unit of the one or more laser units in the exterior to project the one or more laser beams to an area in the exterior to repel birds from that area,

The foregoing examples are not limiting or exclusive, and the scope of the present subject matter is to be determined by the specification as a whole, including the claims and drawings.

The above description includes references to the accompanying drawings, which form a part of the detailed description. The drawings show, by way of illustration, varying embodiments in which the invention can be practiced. The application also refers to “examples.” Such examples can include elements in addition to those shown or described. The foregoing examples are not intended to be an exhaustive or exclusive list of examples and variations of the present subject matter.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

This application is intended to cover adaptations or variations of the present subject matter. It is to be understood that the above description is intended to be illustrative, and not restrictive. The scope of the present invention should be determined with reference to the appended claims, along with the full scope of legal equivalents to which such claims are entitled,

What is claimed is:

1. An apparatus for excluding birds from an enclosure having an entrance, comprising:
a laser projector configured to project one or more laser beams; and
a controller configured to receive a switch signal indicating a state of the entrance and to control at least one of an activation, a direction, or a pattern of the projection of the one or more laser beams using the switch signal.

2. The apparatus of claim 1, further comprising a projection switch coupled to the controller and configured to produce the switch signal, the switch signal indicative at least an opening of the entrance and a closing of the entrance.

3. The apparatus of claim 2, wherein the projection switch comprises an entrance switch configured to open and to close the entrance.

4. The apparatus of claim 2, wherein the projection switch comprises a motion sensor configured to sense the state of the entrance. The apparatus of claim 2, wherein the controller is configured to activate the laser projector to project the one or more laser beams in response to the switch signal indicating the opening of the entrance and to deactivate the laser projector to stop protecting the one or more laser beams in response to the switch signal indicating the closing of the entrance.

6. The apparatus of claim 5, further comprising a timer configured to generate at least one of a minimum time interval and a maximum time interval, and wherein the controller is configured to perform at least one of activating the laser projector to project the one or more laser beams for at least the minimum time interval or deactivating the laser projector to stop protecting the one or more laser beams upon expiration of the maximum time interval.

7. The apparatus of claim 5, wherein the controller is programmable for causing the laser projector to dynamically change at least one of the direction or th pattern of projection of the multiple laser beams when the laser projector is activated.

8. A system for deterring birds in and around an enclosure having one or more entrances, comprising:
multiple laser units each including:
a laser projector configured to project one or more laser beams; and
a controller configured to control at least one of an activation, a direction, or a pattern of the projection of the one or more laser beams,
wherein the multiple laser units include an entrance unit, and the controller of the entrance unit is configured to receive a switch signal indicative of a state of at least one entrance of the one or more entrances and to control the at least one of the activation, the direction, or the pattern of the projection of the one or more laser beams from the laser projector of the entrance unit using the switch signal.

9. The system of claim 8, further comprising a projection switch coupled to the controller of the entrance unit and configured to produce the switch signal, and the controller of the entrance unit is configured to control the projection of the one or more laser beams for preventing the birds from entering the enclosure through the at least one entrance.

10. The system of claim 9, wherein the controller is configured to activate the laser projector of the entrance unit to project the one or more laser beams when the switch signal indicates that the at least one entrance is open and to deactivate the laser projector of the entrance unit to stop projecting the one or more laser beams when the switch signal indicates that the at least one entrance is closed.

11. The system of claim 10, wherein the controller is configured to cause the laser projector of the entrance unit to dynamically change at least one of the direction or the pattern of projection of the one or more laser beams when the laser projector of the entrance unit is activated.

12. The system of claim 8, wherein the multiple laser units further comprises a. sensor-driven unit and a bird sensor communicatively coupled to the controller of the sensor-driven unit, the bird sensor configured to sense presence of one or more birds and to produce a sensor signal indicative of the presence of the one or more birds, the controller of the sensor-driven unit configured to control the at least one of the activation, the direction, or the pattern of the projection of the one or more laser beams from the laser projector of the entrance unit using the sensor signal.

13. The system of claim 8, wherein at least one laser unit of the multiple laser units further comprises a timer configured to generate one or more timing signals, and the controller of the at least one laser unit is configured to control the at least one of the activation, the direction, or the pattern of the projection of the one or more laser beams using the one or more timing signals.

14. A method for bird control for an enclosure having an exterior, an interior, and one or more entrances, comprising:
providing one or more laser units each configured to project one or more laser beams;
designating at least one of the one or more laser units to be an entrance unit for preventing birds from entering the enclosure through at least one entrance of the one or more entrances;
receiving a switch signal indicative of a state of the at least one entrance; and
controlling at least one of an activation, a direction, or a pattern of the projection of the one or more laser beams from the entrance unit using the switch signal.

15. The method of claim 14, further comprising:
generating a clock signal indicative of days and times of the day; and
controlling the at least one of the activation, the direction, or the pattern of the projection of the one or more laser beams from the entrance unit using the switch signal and the clock signal.

16. The method of claim 14, wherein controlling the at least one of the activation, the direction, or the pattern of the projection of the one or more laser beams from the entrance unit using the switch signal comprises:
activating the entrance unit to project the one or more laser beams in response to an opening of the at least one entrance as indicated by the switch signal; and
deactivating the entrance unit to stop projecting the one or more laser beams in response to a closing of the at least one entrance as indicated by the switch signal.

17. The method of claim 16, further comprising:
generating a minimum time interval; and
deactivating the entrance unit to stop projecting the one or more laser beams upon expiration of the minimum time interval when the closing of the at least one entrance is indicated before the expiration of the minimum time interval.

18. The method of claim 16, further comprising:
generating a maximum time interval; and
deactivating the entrance unit to stop projecting the one or more laser beams upon expiration of the maximum time interval when the closing of the at least one entrance is not indicated before the expiration of the maximum time interval.

19. The method of claim 16, further comprising positioning the entrance unit in the interior to project the one or more laser beams to an area around the at least one entrance.

20. The method of claim 16, further comprising positioning the entrance unit in the exterior to project the one or more laser beams to an area around the at least one entrance.

21. The method of claim 14, further comprising controlling the projection of the one or more laser beams from each laser unit of the one or more laser units to cause desirable movements of birds while preventing the birds from becoming acclimated to the one or more laser beams.

22. The method of claim 21, wherein controlling the projection of the one or more laser beams from each laser unit of the one or more laser units comprises at least one of:
dynamically changing the direction of the projection; or
dynamically changing the pattern of the projection.

23. The method of claim 22, wherein controlling the projection of the one or more laser beams from each laser unit of the one or more laser units further comprises:
detecting presence of birds using a motion sensor communicatively coupled to the each laser unit; and
activating the each laser unit to project the one or more laser beams for a period of time in response to each detection of the presence of the birds.

24. The method of claim 22, further comprising positioning at least one interior unit of the one or more laser units in the interior to project the one or more laser beams to an area in the interior to repel birds from that area.

25. The method of claim 22, further comprising positioning at least one exterior unit of the one or more laser units in the exterior to project the one or more laser beams to an area in the exterior to repel birds from that area.
